(19) United States
(12) Patent Application Publication
(10) Pub. No.: US 2023/0192543 A1
(43) Pub. Date: Jun. 22, 2023

(54) SYSTEMS AND METHODS OF CARBON CAPTURE FROM CEMENT PRODUCTION PROCESS

(71) Applicant: Heirloom Carbon Technologies, Inc., San Francisco, CA (US)

(72) Inventors: Noah MCQUEEN, San Francisco, CA (US); Shashank SAMALA, San Francisco, CA (US); Andy DUBEL, Moss Beach, CA (US)

(21) Appl. No.: 18/067,896

(22) Filed: Dec. 19, 2022

Related U.S. Application Data
(60) Provisional application No. 63/291,741, filed on Dec. 20, 2021.

(51) Int. Cl. C04B 7/44; C04B 7/43; C04B 7/36

(52) U.S. Cl. CPC C04B 7/4446; C04B 7/432; C04B 7/4453; C04B 7/434; C04B 7/367; F27M 2003/03

(57) ABSTRACT

Embodiments described herein relate to capturing and sequestering CO₂ emissions from the cement production process with the potential to produce carbon-negative cement. Methods described herein can include contacting calcium oxide (CaO) with ambient air at a carbonation station to form a first stream of calcium carbonate, combining the first stream of calcium carbonate with a second stream of calcium carbonate in a calciner to form a combined stream of calcium carbonate, and applying heat to the calciner to decompose the combined stream of calcium carbonate into a stream of calcium oxide and a CO₂ stream. The method further includes sequestering the CO₂ stream, dividing the stream of calcium oxide into a first calcium oxide stream and a second calcium oxide stream, feeding the first stream of calcium oxide to the carbonation station, and feeding the second stream of calcium oxide to a kiln to produce a clinker.

### CROSS-REFERENCE TO RELATED APPLICATIONS

This application claims priority to and the benefit of U.S. Provisional Patent Application No. 63/291,741, filed Dec. 20, 2021, titled, “Systems and Method of Carbon Capture from Cement Production Process,” the disclosure of which is hereby incorporated by reference in its entirety.

### TECHNICAL FIELD

Embodiments described herein relate to extraction and sequestration of carbon dioxide from a cement production process.

### BACKGROUND

Cement production is an important component of the concrete production process. Cement production facilities are one of the most significant sources of CO₂ emissions worldwide. Roughly 10 billion tons of concrete are produced each year worldwide, and more than 75% of emissions from the concrete production process are from cement production. Each ton of cement produced results in about 0.8 tons of CO₂ emissions. About 50% of cement production emissions are from decarbonation of limestone (i.e., calcium carbonate). In other words, 50% of the cement production emissions occur when limestone is thermally decomposed, according to the following reaction.

CaCO₃+energy→CaO+CO₂

About 20-25% of cement production emissions are from fuel used in heating, calcining, and decarbonating limestone. About 15-20% of emissions are from the fuel used in sintering multiple materials together to produce a clinker. About 10% of emissions are from electricity and general logistics (e.g., grinding at the end of the process). By combatting emissions from the decarbonation step as well as the heating and sintering steps, CO₂ emissions from the process can be substantially reduced by approximately 75%.

### SUMMARY

Embodiments described herein relate to capturing and sequestering CO₂ emissions from the cement production process. Methods described herein can include contacting a carbonation medium including calcium oxide (CaO) with ambient air at a carbonation station to form a first stream of calcium carbonate (CaCO₃), combining the first stream of CaCO₃ with a second stream of CaCO₃ to form a calciner input stream of CaCO₃, and applying heat to the calciner to decompose the combined stream of CaCO₃ into a calciner product stream including CaO and a CO₂ stream. The method further includes sequestering the CO₂ stream, dividing the calciner product stream into a first stream including CaO and a second stream including CaO, feeding the first stream including CaO to the carbonation station, and feeding the second stream including CaO to a kiln to produce a clinker. In some embodiments, the second stream of CaCO₃ can include naturally occurring limestone. In some embodiments, the method can further include adding clay and/or iron ore to the second stream of CaO prior to feeding the second stream of CaO to the kiln. In some embodiments, the method can include hydroxylating at least a portion of the CaO in the first stream including CaO to produce Ca(OH)₂. The Ca(OH)₂ can react with CO₂ in the ambient air to produce CaCO₃ and water.

### BRIEF DESCRIPTION OF THE DRAWINGS

FIG. 1 is a block diagram of a method of carbon capture from a cement production process, according to an embodiment.

FIG. 2 is a block diagram of a cement production facility, according to an embodiment.

FIG. 3 is an illustration of a cement production facility, according to an embodiment.

FIG. 4 shows a material balance for prevention of CO₂ emissions via integration of carbonation stations into a cement production process, according to various embodiments.

### DETAILED DESCRIPTION

Cement production commonly includes grinding limestone, clays, and iron ore together and feeding the resulting mixture to a rotary kiln to produce a clinker. The rotary kiln is heated to about 1,450° C. This decarbonates the limestone and releases a significant amount of CO₂ into the atmosphere. Most of the decarbonation occurs at a temperature of about 700-1,000° C. Energy input to decarbonate the limestone is about 1.7 GJ per ton of clinker produced. This is about half the total energy of a modern dry process kiln. During the kiln process, the composition of the mixture changes over time. First water dries out, and then CO₂ is released from the CaCO₃. When decarbonation is complete at about 1,100° C., the feed temperature begins to rise more rapidly.

Lime or CaO reacts with silica to form belite, but the lime does not begin to substantially react until the temperature reaches about 1,250° C. This is the lower limit temperature for thermodynamic stability of alite. At a temperature of about 1,300° C., partial melting occurs, with the liquid phase coming from alumina and iron oxide. Unreacted lime reduces as belite and is converted to alite. Less than about 3% of the lime is unreacted by the end of the process. CaO is about 65% by weight of the clinker. The CO₂ that escapes from the limestone decarbonation, and the CO₂ from the fuel that energizes the decarbonation process combine to make up about 75% by weight of all cement emissions.

Portland cement includes four main chemical compounds: alite, belite, aluminite, and ferrite. Alite and belite are important for strength development and long term structural and durability properties of cement. The reaction between CaO and silicon dioxide (SiO₂) is difficult to achieve, even at high firing temperatures. Chemical combination is greatly facilitated if small quantities of alumina and iron oxide are present, as they help form molten flux. Lime and silica can partially dissolve and react with alite and belite in the molten flux.

By dividing the heating into two separate stages (one for calcining, and one for high temperature heating), CO₂ contactors can be integrated into the process to reduce emissions from the CaO production process (i.e., calcination). First, a calciner can be used to decarbonate the CaCO₃ to capture and store CO₂ and produce CaO. Then, contactors can capture CO₂ from ambient air using the CaO to produce mostly CaCO₃. The resulting CaCO₃ can be re-calcined and more CO₂ can be captured and stored. Then the CaO can be sent to a sintering stage to produce a clinker in a rotary kiln. Some of the contactors described herein can be the same or substantially similar to those described in International Patent Publication WO2020/263910 (“the '910 publication”), filed Jun. 24, 2020, titled, “System and Methods for Enhanced Weathering and Calcining for CO₂ Removal from Air,” and U.S. Provisional Patent Application No. 63/155,572 (“the '572 application”), filed Mar. 2, 2021, titled “Systems and Methods for Enhanced Weathering and Calcining for CO₂ Removal from Air,” the disclosures of which are hereby incorporated by reference in their entireties.

As used herein, “carbonation plot,” includes single contiguous plots, as well as semi- or non-contiguous plots that are then grouped or processed together to effectively act as a single plot. In some embodiments, carbonation plots include a composition that sequesters a target compound (e.g., CO₂). In some embodiments, carbonation plots are positioned and configured to expose the composition to ambient conditions.

As used herein, “stream” can refer to stream that includes solid, liquid, and/or gas. For example, a stream can include a solid in granular form conveyed on a conveyor device. A stream can also include a liquid and/or gas flowing through a pipe. A stream can include a solution.

As used in this specification, the singular forms “a,” “an,” and “the” include plural referents unless the context clearly dictates otherwise. Thus, for example, the term “a member” is intended to mean a single member or a combination of members, “a material” is intended to mean one or more materials, or a combination thereof.

The term “substantially” when used in connection with “cylindrical,” “linear,” and/or other geometric relationships is intended to convey that the structure so defined is nominally cylindrical, linear or the like. As one example, a portion of a support member that is described as being “substantially linear” is intended to convey that, although linearity of the portion is desirable, some non-linearity can occur in a “substantially linear” portion. Such non-linearity can result from manufacturing tolerances, or other practical considerations (such as, for example, the pressure or force applied to the support member). Thus, a geometric construction modified by the term “substantially” includes such geometric properties within a tolerance of plus or minus 5% of the stated geometric construction. For example, a “substantially linear” portion is a portion that defines an axis or center line that is within plus or minus 5% of being linear.

As used herein, the term “set” and “plurality” can refer to multiple features or a singular feature with multiple parts. For example, when referring to a set of electrodes, the set of electrodes can be considered as one electrode with multiple portions, or the set of electrodes can be considered as multiple, distinct electrodes. Additionally, for example, when referring to a plurality of electrochemical cells, the plurality of electrochemical cells can be considered as multiple, distinct electrochemical cells or as one electrochemical cell with multiple portions. Thus, a set of portions or a plurality of portions may include multiple portions that are either continuous or discontinuous from each other. A plurality of particles or a plurality of materials can also be fabricated from multiple items that are produced separately and are later joined together (e.g., via mixing, an adhesive, or any suitable method).

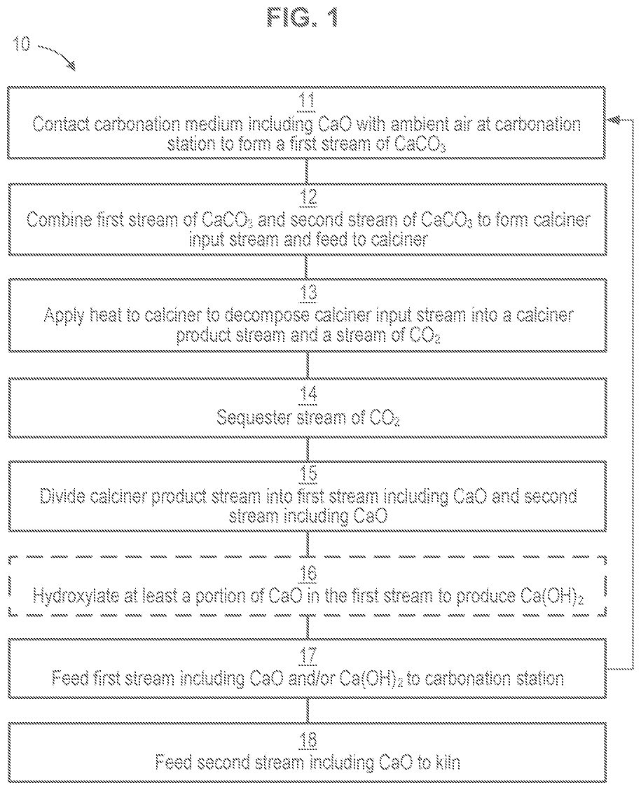

FIG. 1 is a block diagram of a method 10 of carbon capture from a cement production process, according to an embodiment. As shown, the method 10 includes contacting carbonation medium including CaO with ambient air at a carbonation station to form a first stream of CaCO₃ at step 11. The method 10 further includes combining the first stream of CaCO₃ and a second stream of CaCO₃ to form a calciner input stream and feeding the calciner input stream to a calciner at step 12. The method 10 further includes applying heat to the calciner to decompose the combined stream of CaCO₃ into a calciner product stream including CaO and a stream of CO₂ at step 13. The method 10 further includes sequestering the stream of CO₂ at step 14 and dividing the calciner product stream into a first stream and a second stream at step 15. The method 10 optionally includes hydrating or hydroxylating at least a portion of the CaO in the first stream to produce Ca(OH)₂. The method 10 further includes feeding the first stream including CaO and/or Ca(OH)₂ to the carbonation station at step 17, and feeding the second stream of CaO to a kiln for clinker production at step 18. In some embodiments, the method 10 can be a continuous process. The steps can occur in any sequence, with temporal overlapping as well. In some embodiments, the method 10 can be tuned to ensure that each calcium atom goes through the calciner an average of about two times.

Step 11 includes contacting a carbonation medium including CaO with ambient air at a carbonation station to form a first stream of CaCO₃. The CaO reacts with CO₂ in the ambient air to form CaCO₃. In some embodiments, the method 10 can initiate with step 11. In other words, the CaO can contact the ambient air prior to feeding any CaCO₃ to the calciner. In some embodiments, the CaO contacting the ambient air can be in powder form. In some embodiments, the CaO can be arranged in stacks. In some embodiments, the CaO can be arranged in any of the configurations described in the '910 publication and/or the '572 application. CaO reacts with CO₂ to form CaCO₃ in accordance with the following reactions.

CaO+H₂O→Ca(OH)₂

Ca(OH)₂+CO₂→CaCO₃+H₂O

In some embodiments, step 11 can include contacting Ca(OH)₂ with CO₂ to form water and CaCO₃. As described below with respect to step 16, at least a portion of the CaO can be hydrated to form Ca(OH)₂. Ca(OH)₂ reacts with CO₂ in accordance with the following reaction.

Ca(OH)₂+CO₂→CaCO₃+H₂O

In some embodiments, the water formed from the carbonation of Ca(OH)₂ can be condensed and stored. In some embodiments, the water can be pumped through one or more pipes to a location external to the carbonation station. In some embodiments, the water can evaporate.

In some embodiments, the carbonation medium contacting the ambient air at the carbonation station can include at least about 0.5 wt %, at least about 1 wt %, at least about 1.5 wt %, at least about 2 wt %, at least about 2.5 wt %, at least about 3 wt %, at least about 3.5 wt %, at least about 4 wt %, at least about 4.5 wt %, at least about 5 wt %, at least about 5.5 wt %, at least about 6 wt %, at least about 6.5 wt %, at least about 7 wt %, at least about 7.5 wt %, at least about 8 wt %, at least about 8.5 wt %, at least about 9 wt %, at least about 9.5 wt %, at least about 10 wt %, at least about 15 wt %, at least about 20 wt %, at least about 25 wt %, at least about 30 wt %, at least about 35 wt %, at least about 40 wt %, at least about 45 wt %, at least about 50 wt %, at least about 55 wt %, at least about 60 wt %, at least about 65 wt %, at least about 70 wt %, at least about 75 wt %, at least about 80 wt %, at least about 85 wt %, at least about 90 wt %, at least about 90.5 wt %, at least about 91 wt %, at least about 91.5 wt %, at least about 92 wt %, at least about 92.5 wt %, at least about 93 wt %, at least about 93.5 wt %, at least about 94 wt %, at least about 94.5 wt %, at least about 95 wt %, at least about 95.5 wt %, at least about 96 wt %, at least about 96.5 wt %, at least about 97 wt %, at least about 97.5 wt %, at least about 98 wt %, at least about 98.5 wt %, or at least about 99 wt % Ca(OH)₂. In some embodiments, the carbonation medium can include no more than about 99.9 wt %, no more than about 99.5 wt %, no more than about 99 wt %, no more than about 98.5 wt %, no more than about 98 wt %, no more than about 97.5 wt %, no more than about 97 wt %, no more than about 96.5 wt %, no more than about 96 wt %, no more than about 95.5 wt %, no more than about 95 wt %, no more than about 94.5 wt %, no more than about 94 wt %, no more than about 93.5 wt %, no more than about 93 wt %, no more than about 92.5 wt %, no more than about 92 wt %, no more than about 91.5 wt %, no more than about 91 wt %, no more than about 90.5 wt %, no more than about 90 wt %, no more than about 85 wt %, no more than about 80 wt %, no more than about 75 wt %, no more than about 70 wt %, no more than about 65 wt %, no more than about 60 wt %, no more than about 55 wt %, no more than about 50 wt %, no more than about 45 wt %, no more than about 40 wt %, no more than about 35 wt %, no more than about 30 wt %, no more than about 25 wt %, no more than about 20 wt %, no more than about 15 wt %, no more than about 10 wt %, no more than about 9.5 wt %, no more than about 9 wt %, no more than about 8.5 wt %, no more than about 8 wt %, no more than about 7.5 wt %, no more than about 7 wt %, no more than about 6.5 wt %, no more than about 6 wt %, no more than about 5.5 wt %, no more than about 5 wt %, no more than about 4.5 wt %, no more than about 4 wt %, no more than about 3.5 wt %, no more than about 3 wt %, no more than about 2.5 wt %, no more than about 2 wt %, no more than about 1.5 wt %, or no more than about 1 wt % Ca(OH)₂.

Combinations of the above-referenced weight percentages of Ca(OH)₂ in the carbonation medium are also possible (e.g., at least about 0.5 wt % and no more than about 99.5 wt % or at least about 5 wt % and no more than about 20 wt %), inclusive of all values and ranges therebetween. In some embodiments, the carbonation medium contacting the ambient air at the carbonation station can include about 0.5 wt %, about 1 wt %, about 1.5 wt %, about 2 wt %, about 2.5 wt %, about 3 wt %, about 3.5 wt %, about 4 wt %, about 4.5 wt %, about 5 wt %, about 5.5 wt %, about 6 wt %, about 6.5 wt %, about 7 wt %, about 7.5 wt %, about 8 wt %, about 8.5 wt %, about 9 wt %, about 9.5 wt %, about 10 wt %, about 15 wt %, about 20 wt %, about 25 wt %, about 30 wt %, about 35 wt %, about 40 wt %, about 45 wt %, about 50 wt %, about 55 wt %, about 60 wt %, about 65 wt %, about 70 wt %, about 75 wt %, about 80 wt %, about 85 wt %, about 90 wt %, about 90.5 wt %, about 91 wt %, about 91.5 wt %, about 92 wt %, about 92.5 wt %, about 93 wt %, about 93.5 wt %, about 94 wt %, about 94.5 wt %, about 95 wt %, about 95.5 wt %, about 96 wt %, about 96.5 wt %, about 97 wt %, about 97.5 wt %, about 98 wt %, about 98.5 wt %, about 99 wt %, about 99.5 wt %, or about 99.9 wt % Ca(OH)₂.

In some embodiments, the carbonation medium contacting the ambient air at the carbonation station can include at least about 0.5 wt %, at least about 1 wt %, at least about 1.5 wt %, at least about 2 wt %, at least about 2.5 wt %, at least about 3 wt %, at least about 3.5 wt %, at least about 4 wt %, at least about 4.5 wt %, at least about 5 wt %, at least about 5.5 wt %, at least about 6 wt %, at least about 6.5 wt %, at least about 7 wt %, at least about 7.5 wt %, at least about 8 wt %, at least about 8.5 wt %, at least about 9 wt %, at least about 9.5 wt %, at least about 10 wt %, at least about 15 wt %, at least about 20 wt %, at least about 25 wt %, at least about 30 wt %, at least about 35 wt %, at least about 40 wt %, at least about 45 wt %, at least about 50 wt %, at least about 55 wt %, at least about 60 wt %, at least about 65 wt %, at least about 70 wt %, at least about 75 wt %, at least about 80 wt %, at least about 85 wt %, at least about 90 wt %, at least about 90.5 wt %, at least about 91 wt %, at least about 91.5 wt %, at least about 92 wt %, at least about 92.5 wt %, at least about 93 wt %, at least about 93.5 wt %, at least about 94 wt %, at least about 94.5 wt %, at least about 95 wt %, at least about 95.5 wt %, at least about 96 wt %, at least about 96.5 wt %, at least about 97 wt %, at least about 97.5 wt %, at least about 98 wt %, at least about 98.5 wt %, or at least about 99 wt % CaO. In some embodiments, the carbonation medium can include no more than about 99.5 wt %, no more than about 99 wt %, no more than about 98.5 wt %, no more than about 98 wt %, no more than about 97.5 wt %, no more than about 97 wt %, no more than about 96.5 wt %, no more than about 96 wt %, no more than about 95.5 wt %, no more than about 95 wt %, no more than about 94.5 wt %, no more than about 94 wt %, no more than about 93.5 wt %, no more than about 93 wt %, no more than about 92.5 wt %, no more than about 92 wt %, no more than about 91.5 wt %, no more than about 91 wt %, no more than about 90.5 wt %, no more than about 90 wt %, no more than about 85 wt %, no more than about 80 wt %, no more than about 75 wt %, no more than about 70 wt %, no more than about 65 wt %, no more than about 60 wt %, no more than about 55 wt %, no more than about 50 wt %, no more than about 45 wt %, no more than about 40 wt %, no more than about 35 wt %, no more than about 30 wt %, no more than about 25 wt %, no more than about 20 wt %, no more than about 15 wt %, no more than about 10 wt %, no more than about 9.5 wt %, no more than about 9 wt %, no more than about 8.5 wt %, no more than about 8 wt %, no more than about 7.5 wt %, no more than about 7 wt %, no more than about 6.5 wt %, no more than about 6 wt %, no more than about 5.5 wt %, no more than about 5 wt %, no more than about 4.5 wt %, no more than about 4 wt %, no more than about 3.5 wt %, no more than about 3 wt %, no more than about 2.5 wt %, no more than about 2 wt %, no more than about 1.5 wt %, or no more than about 1 wt % CaO.

Combinations of the above-referenced weight percentages of CaO in the carbonation medium are also possible (e.g., at least about 0.5 wt % and no more than about 99.5 wt % or at least about 70 wt % and no more than about 90 wt %), inclusive of all values and ranges therebetween. In some embodiments, the carbonation medium contacting the ambient air at the carbonation station can include about 0.5 wt %, about 1 wt %, about 1.5 wt %, about 2 wt %, about 2.5 wt %, about 3 wt %, about 3.5 wt %, about 4 wt %, about 4.5 wt %, about 5 wt %, about 5.5 wt %, about 6 wt %, about 6.5 wt %, about 7 wt %, about 7.5 wt %, about 8 wt %, about 8.5 wt %, about 9 wt %, about 9.5 wt %, about 10 wt %, about 15 wt %, about 20 wt %, about 25 wt %, about 30 wt %, about 35 wt %, about 40 wt %, about 45 wt %, about 50 wt %, about 55 wt %, about 60 wt %, about 65 wt %, about 70 wt %, about 75 wt %, about 80 wt %, about 85 wt %, about 90 wt %, about 90.5 wt %, about 91 wt %, about 91.5 wt %, about 92 wt %, about 92.5 wt %, about 93 wt %, about 93.5 wt %, about 94 wt %, about 94.5 wt %, about 95 wt %, about 95.5 wt %, about 96 wt %, about 96.5 wt %, about 97 wt %, about 97.5 wt %, about 98 wt %, about 98.5 wt %, about 99 wt %, or about 99.5 wt % CaO.

Step 12 includes combining the first stream of CaCO₃ and the second stream of CaCO₃ to form a calciner input stream of CaCO₃ and feeding the calciner input stream to the calciner. In some embodiments, the first stream of CaCO₃ and/or the second stream of CaCO₃ can be fed to the calciner via a series of conveyors. The second stream of CaCO₃ can include naturally occurring limestone. In some embodiments, the second stream of CaCO₃ can include fresh limestone (i.e., virgin limestone from limestone deposits). In some embodiments, the second stream of CaCO₃ can act as a makeup stream to compensate for calcium-containing materials fed to the kiln. In some embodiments, the naturally occurring limestone can include mined limestone. In some embodiments, the method 10 can initiate temporally with the feeding of fresh limestone into the calciner. In some embodiments, the first stream of CaCO₃ and the second stream of CaCO₃ can be combined outside of the calciner (e.g., via a mixer) prior to entering the calciner. In some embodiments, the first stream of CaCO₃ and the second stream of CaCO₃ can enter the calciner separately and be combined in the calciner. In some embodiments, the flow rate of the first stream of CaCO₃ and/or the second stream of CaCO₃ into the calciner can be monitored and/or controlled. Monitoring the flow of CaCO₃ streams into the calciner can be via solids flowmeters, solid particle mass flow meters, weigh belts, impact meters, loss-in-weight meters, static weigh scales, Coriolis mass flowmeters, or any other suitable means of solid flow measurement. In some embodiments, flow of the first stream of CaCO₃ and/or the second stream of CaCO₃ can be controlled via gates and/or valves disposed on or near the calciner. In some embodiments, the step 11 and/or step 12 can include production of carbon-containing streams that include substances other than CaCO₃ or in addition to CaCO₃. For example, the carbon-containing streams can include magnesium carbonates (MgCO₃), sodium carbonates (Na₂CO₃), and/or sodium bicarbonates (NaHCO₃). Accordingly, the carbonation medium precursors to the carbon-containing streams can include magnesium oxide (MgO), sodium oxide (Na₂O), and/or sodium hydroxide (Na(OH)₂).

In some embodiments, the flow ratio of the first stream of CaCO₃ (i.e., the stream from the carbonation station) to the second stream of CaCO₃ (i.e., the naturally occurring limestone stream) can be at least about 0.01:1, at least about 0.02:1, at least about 0.03:1, at least about 0.04:1, at least about 0.05:1, at least about 0.06:1, at least about 0.07:1, at least about 0.08:1, at least about 0.09:1, at least about 0.1:1, at least about 0.15:1, at least about 0.2:1, at least about 0.25:1, at least about 0.3:1, at least about 0.35:1, at least about 0.4:1, at least about 0.45:1, at least about 0.5:1, at least about 0.55:1, at least about 0.6:1, at least about 0.65:1, at least about 0.7:1, at least about 0.75:1, at least about 0.8:1, at least about 0.85:1, at least about 0.9:1, at least about 0.95:1, at least about 0.1:1, at least about 1:1, at least about 1.1:1, at least about 1.2:1, at least about 1.3:1, at least about 1.4:1, at least about 1.5:1, at least about 1.6:1, at least about 1.7:1, at least about 1.8:1, or at least about 1.9:1. In some embodiments, the flow ratio of the first stream of CaCO₃ to the second stream of CaCO₃ can be no more than about 2:1, no more than about 1.95:1, no more than about 1.9:1, no more than about 1.85:1, no more than about 1.8:1, no more than about 1.75:1, no more than about 1.7:1, no more than about 1.65:1, no more than about 1.6:1, no more than about 1.55:1, no more than about 1.5:1, no more than about 1.45:1, no more than about 1.4:1, no more than about 1.35:1, no more than about 1.3:1, no more than about 1.25:1, no more than about 1.2:1, no more than about 1.15:1, no more than about 1.1:1, no more than about 1.05:1, no more than about 1:1, no more than about 0.95:1, no more than about 0.9:1, no more than about 0.85:1, no more than about 0.8:1, no more than about 0.75:1, no more than about 0.7:1, no more than about 0.65:1, no more than about 0.6:1, no more than about 0.55:1, no more than about 0.5:1, no more than about 0.45:1, no more than about 0.4:1, no more than about 0.35:1, no more than about 0.3:1, no more than about 0.25:1, no more than about 0.2:1, no more than about 0.15:1, no more than about 0.1:1, no more than about 0.09:1, no more than about 0.08:1, no more than about 0.07:1, no more than about 0.06:1, no more than about 0.05:1, no more than about 0.04:1, no more than about 0.03:1, or no more than about 0.02:1.

Combinations of the above-referenced flow ratios of the first stream of CaCO₃ to the second stream of CaCO₃ are also possible (e.g., at least about 0.01:1 and no more than about 2:1 or at least about 0.5:1 and no more than about 1:1), inclusive of all values and ranges therebetween. In some embodiments, the flow ratio of the first stream of CaCO₃ to the second stream of CaCO₃ can be about 0.01:1, about 0.02:1, about 0.03:1, about 0.04:1, about 0.05:1, about 0.06:1, about 0.07:1, about 0.08:1, about 0.09:1, about 0.1:1, about 0.15:1, about 0.2:1, about 0.25:1, about 0.3:1, about 0.35:1, about 0.4:1, about 0.45:1, about 0.5:1, about 0.55:1, about 0.6:1, about 0.65:1, about 0.7:1, about 0.75:1, about 0.8:1, about 0.85:1, about 0.9:1, about 0.95:1, about 0.1:1, about 1:1, about 1.1:1, about 1.2:1, about 1.3:1, about 1.4:1, about 1.5:1, about 1.6:1, about 1.7:1, about 1.8:1, about 1.9:1, or about 2:1.

Step 13 includes applying heat to the calciner to decompose the combined stream of CaCO₃ into calciner product stream including CaO and a stream of CO₂. This decomposition occurs according to the following reaction:

CaCO₃+energy(heat)→CaO+CO₂

In some embodiments, the heat can be applied at least partially by renewable electricity. For example, the heat can be applied at least partially by renewable electricity via solar power, wind power, nuclear power, geothermal power, and/or any other suitable renewable or low carbon energy source or combinations thereof. In some embodiments, all or substantially all of the heat can be applied by renewable or low carbon energy. In some embodiments, the calcining temperature can be at least about 500° C., at least about 550° C., at least about 600° C., at least about 650° C., at least about 700° C., at least about 750° C., at least about 800° C., at least about 850° C., at least about 900° C., at least about 950° C., at least about 1,000° C., or at least about 1,050° C. In some embodiments, the calcining temperature can be no more than about 1,100° C., no more than about 1,050° C., no more than about 1,000° C., no more than about 950° C., no more than about 900° C., no more than about 850° C., no more than about 800° C., no more than about 750° C., no more than about 700° C., no more than about 650° C., no more than about 600° C., or no more than about 550° C. Combinations of the above-referenced calcining temperatures are also possible (e.g., at least about 500° C. and no more than about 1,100° C. or at least about 600° C. and no more than about 800° C.), inclusive of all values and ranges therebetween. In some embodiments, the calcining temperature can be about 500° C., about 550° C., about 600° C., about 650° C., about 700° C., about 750° C., about 800° C., about 850° C., about 900° C., about 950° C., about 1,000° C., about 1,050° C., or about 1,100° C.

Step 14 includes sequestering the stream of CO₂. In some embodiments, the CO₂ stream can rise from the calciner and be delivered to a storage facility via pipes. In some embodiments, the CO₂ stream can be compressed to desired transport conditions (i.e., a transport pressure) and pumped via pipeline to a storage location. In some embodiments, the transport pressure can be about 2 bar, about 3 bar, about 4 bar, about 5 bar, about 6 bar, about 7 bar, about 8 bar, about 9 bar, about 10 bar, about 15 bar, about 20 bar, about 25 bar, about 30 bar, about 35 bar, about 40 bar, about 45 bar, about 50 bar, about 55 bar, about 60 bar, about 65 bar, about 70 bar, about 75 bar, about 80 bar, about 85 bar, about 90 bar, about 95 bar, about 100 bar, about 110 bar, about 120 bar, about 130 bar, about 140 bar, about 150 bar, about 160 bar, about 170 bar, about 180 bar, about 190 bar, or about 200 bar, inclusive of all values and ranges therebetween.

In some embodiments, the CO₂ stream can be subject to post-processing prior to storage such that the CO₂ stream is compliant with applicable specifications for storage. In some embodiments, the post-processing can include dehydration (e.g., via a condenser) and/or compression (e.g., via a compressor). In some embodiments, the CO₂ stream can have a high purity. In some embodiments, the CO₂ stream can include at least about 80 vol %, at least about 85 vol %, at least about 90 vol %, at least about 91 vol %, at least about 92 vol %, at least about 93 vol %, at least about 94 vol %, at least about 95 vol %, at least about 96 vol %, at least about 97 vol %, at least about 98 vol %, at least about 99 vol %, at least about 99.1 vol %, at least about 99.2 vol %, at least about 99.3 vol %, at least about 99.4 vol %, at least about 99.5 vol %, at least about 99.6 vol %, at least about 99.7 vol %, at least about 99.8 vol %, at least about 99.9 vol %, at least about 99.99 vol %, or at least about 99.999 vol % CO₂. In some embodiments, the CO₂ stream can be purified via condensation of water or other post processing treatment. In some embodiments, the CO₂ stream can be compressed into gas storage. In some embodiments, the compressed CO₂ stream can be direct injected in a co-located facility. In some embodiments, the compressed CO₂ stream can be transported to a location where it can be sequestered.

Steps 15, 17, and 18 include dividing the CaO into a first stream and a second stream to be fed to the contactors and a kiln, respectively. Optional step 16 includes hydrating at least a portion of the first stream. Upon hydrating the first stream, the CaO is converted to Ca(OH)₂ in accordance with the following equation.

CaO+H₂O→Ca(OH)₂+heat

Hydrating the CaO to form Ca(OH)₂ can improve the affinity of the carbonation station to capture CO₂. For example, the reaction between Ca(OH)₂ and CO₂ can have lower activation energy than the reaction between CaO and CO₂. The residence time of a carbonation mix including Ca(OH)₂ at the carbonation station can be less than the residence time a carbonation mixture without Ca(OH)₂. Hydration of the CaO can also allow for recovery of heat from the hydration reaction, as the reaction is exothermic. In some embodiments, the hydration can be achieved by passing the CaO through a humid enclosure (e.g., with at least about 50%, at least about 60%, at least about 70%, at least about 80%, at least about 90%, or about 100% relative humidity, inclusive of all values and ranges therebetween). In some embodiments, the hydration can be achieved by misting water onto the CaO (e.g., via one or more sprayers). In some embodiments, the hydration can be achieved by placing the CaO in a water bath. In some embodiments, the hydration can be achieved via any of the methods described in the '572 application.

In some embodiments, at least about 0.5 wt %, at least about 1 wt %, at least about 1.5 wt %, at least about 2 wt %, at least about 2.5 wt %, at least about 3 wt %, at least about 3.5 wt %, at least about 4 wt %, at least about 4.5 wt %, at least about 5 wt %, at least about 5.5 wt %, at least about 6 wt %, at least about 6.5 wt %, at least about 7 wt %, at least about 7.5 wt %, at least about 8 wt %, at least about 8.5 wt %, at least about 9 wt %, at least about 9.5 wt %, at least about 10 wt %, at least about 15 wt %, at least about 20 wt %, at least about 25 wt %, at least about 30 wt %, at least about 35 wt %, at least about 40 wt %, at least about 45 wt %, at least about 50 wt %, at least about 55 wt %, at least about 60 wt %, at least about 65 wt %, at least about 70 wt %, at least about 75 wt %, at least about 80 wt %, at least about 85 wt %, at least about 90 wt %, or at least about 95 wt % of the CaO in the first stream is converted to Ca(OH)₂. In some embodiments, no more than about 97 wt %, no more than about 95 wt %, no more than about 90 wt %, no more than about 85 wt %, no more than about 80 wt %, no more than about 75 wt %, no more than about 70 wt %, no more than about 65 wt %, no more than about 60 wt %, no more than about 55 wt %, no more than about 50 wt %, no more than about 45 wt %, no more than about 40 wt %, no more than about 35 wt %, no more than about 30 wt %, no more than about 25 wt %, no more than about 20 wt %, no more than about 15 wt %, no more than about 10 wt %, no more than about 9.5 wt %, no more than about 9 wt %, no more than about 8.5 wt %, no more than about 8 wt %, no more than about 7.5 wt %, no more than about 7 wt %, no more than about 6.5 wt %, no more than about 6 wt %, no more than about 5.5 wt %, no more than about 5 wt %, no more than about 4.5 wt %, no more than about 4 wt %, no more than about 3.5 wt %, no more than about 3 wt %, no more than about 2.5 wt %, no more than about 2 wt %, no more than about 1.5 wt %, or no more than about 1 wt % of the CaO in the first stream is converted to Ca(OH)₂. Combinations of the above-referenced weight percentages of the first stream of CaO converted to Ca(OH)₂ are also possible (e.g., at least about 0.5 wt % and no more than about 97 wt % or at least about 50 wt % and no more than about 90 wt %), inclusive of all values and ranges therebetween. In some embodiments, about 0.5 wt %, about 1 wt %, about 1.5 wt %, about 2 wt %, about 2.5 wt %, about 3 wt %, about 3.5 wt %, about 4 wt %, about 4.5 wt %, about 5 wt %, about 5.5 wt %, about 6 wt %, about 6.5 wt %, about 7 wt %, about 7.5 wt %, about 8 wt %, about 8.5 wt %, about 9 wt %, about 9.5 wt %, about 10 wt %, about 15 wt %, about 20 wt %, about 25 wt %, about 30 wt %, about 35 wt %, about 40 wt %, about 45 wt %, about 50 wt %, about 55 wt %, about 60 wt %, about 65 wt %, about 70 wt %, about 75 wt %, about 80 wt %, about 85 wt %, about 90 wt %, about 95 wt %, or about 97 wt % of the CaO in the first stream is converted to Ca(OH)₂.

At step 17, the first stream is fed back to the contactors to contact ambient air and form CaCO₃ (i.e., step 11). At step 18, the second stream is fed to a kiln. In some embodiments, the first stream and/or the second stream can include some residual CaCO₃. In some embodiments, the division between the first CaO stream and the second CaO stream can be via a splitter. In some embodiments, the flow ratio of the first CaO stream to the second CaO stream can be at least about 0.1:1, at least about 0.2:1, at least about 0.3:1, at least about 0.4:1, at least about 0.5:1, at least about 0.6:1, at least about 0.7:1, at least about 0.8:1, at least about 0.9:1, at least about 1:1, at least about 1.5:1, at least about 2:1, at least about 2.5:1, at least about 3:1, at least about 3.5:1, at least about 4:1, at least about 4.5:1, at least about 5:1, at least about 5.5:1, at least about 6:1, at least about 6.5:1, at least about 7:1, at least about 7.5:1, at least about 8:1, at least about 8.5:1, at least about 9:1, or at least about 9.5:1. In some embodiments, the flow ratio of the first CaO stream to the second CaO stream can be no more than about 10:1, no more than about 9.5:1, no more than about 9:1, no more than about 8.5:1, no more than about 8:1, no more than about 7.5:1, no more than about 7:1, no more than about 6.5:1, no more than about 6:1, no more than about 5.5:1, no more than about 5:1, no more than about 4.5:1, no more than about 4:1, no more than about 3.5:1, no more than about 3:1, no more than about 2.5:1, no more than about 2:1, no more than about 1.5:1, no more than about 1:1, no more than about 0.9:1, no more than about 0.8:1, no more than about 0.7:1, no more than about 0.6:1, no more than about 0.5:1, no more than about 0.4:1, no more than about 0.3:1, or no more than about 0.2:1.

Combinations of the above-referenced flow ratios of the first CaO stream to the second CaO stream are also possible (e.g., at least about 0.1:1 and no more than about 10:1), inclusive of all values and ranges therebetween. In some embodiments, the flow ratio of the first CaO stream to the second CaO stream can be about 0.1:1, about 0.2:1, about 0.3:1, about 0.4:1, about 0.5:1, about 0.6:1, about 0.7:1, about 0.8:1, about 0.9:1, about 1:1, about 1.5:1, about 2:1, about 2.5:1, about 3:1, about 3.5:1, about 4:1, about 4.5:1, about 5:1, about 5.5:1, about 6:1, about 6.5:1, about 7:1, about 7.5:1, about 8:1, about 8.5:1, about 9:1, about 9.5:1, or about 10:1.

In some embodiments, clay and/or iron ore can be added to the second CaO stream prior to feeding the second CaO stream to the kiln at step 18. In some embodiments, the kiln can include a rotary kiln. In some embodiments, the second CaO stream can be sintered in the kiln. In some embodiments, the temperature of the sintering can be about 1,200° C., about 1,250° C., about 1,300° C., about 1,350° C., about 1,400° C., about 1,450° C., about 1,500° C., about 1,550° C., about 1,600° C., about 1,650° C., or about 1,700° C., inclusive of all values and ranges therebetween. A clinker is produced from the kiln process. In some embodiments, gypsum and/or slag can be added to the clinker. The clinker, slag, and gypsum can be grinded to form cement.

In some embodiments, the method 10 can be tuned to control the average number of times each calcium atom passes through the calciner. This passage number can be tuned via the tuning of the feed ratio of the first and second streams of CaCO₃ into the calciner and the split ratio of the first and second CaO streams exiting the calciner. For example, if the feed ratio of the first and second streams of CaCO₃ into the calciner and the split ratio of the first and second CaO streams exiting the calciner are both 1:1, then the average calcium atom would go through the calciner exactly two times.

In some embodiments, the average number of passes through the calciner of each calcium atom can be at least about 1.1, at least about 1.2, at least about 1.3, at least about 1.4, at least about 1.5, at least about 1.6, at least about 1.7, at least about 1.8, at least about 1.9, at least about 2, at least about 2.1, at least about 2.2, at least about 2.3, at least about 2.4, at least about 2.5, at least about 2.6, at least about 2.7, at least about 2.8, at least about 2.9, at least about 3, at least about 3.5, at least about 4, at least about 4.5, at least about 5, at least about 5.5, at least about 6, at least about 6.5, at least about 7, at least about 7.5, at least about 8, at least about 8.5, at least about 9, or at least about 9.5. In some embodiments, the average number of passes through the calciner of each calcium ion can be no more than about 10, no more than about 9.5, no more than about 9, no more than about 8.5, no more than about 8, no more than about 7.5, no more than about 7, no more than about 6.5, no more than about 6, no more than about 5.5, no more than about 5, no more than about 4.5, no more than about 4, no more than about 3.5, no more than about 3, no more than about 2.9, no more than about 2.8, no more than about 2.7, no more than about 2.6, no more than about 2.5, no more than about 2.4, no more than about 2.3, or no more than about 2.2, no more than about 2.1, no more than about 2, no more than about 1.9, no more than about 1.8, no more than about 1.7, no more than about 1.6, no more than about 1.5, no more than about 1.4, no more than about 1.3, or no more than about 1.2. Combinations of the above-referenced average number of passes of the calcium atoms through the calciner are also possible (e.g., at least about 1.1 and no more than about 10 or at least about 1.5 and no more than about 2.5), inclusive of all values and ranges therebetween. In some embodiments, the average number of passes through the calciner of each calcium atom can be about 1.1, about 1.2, about 1.3, about 1.4, about 1.5, about 1.6, about 1.7, about 1.8, about 1.9, about 2, about 2.1, about 2.2, about 2.3, about 2.4, about 2.5, about 2.6, about 2.7, about 2.8, about 2.9, about 3, about 3.5, about 4, about 4.5, about 5, about 5.5, about 6, about 6.5, about 7, about 7.5, about 8, about 8.5, about 9, about 9.5, or about 10.

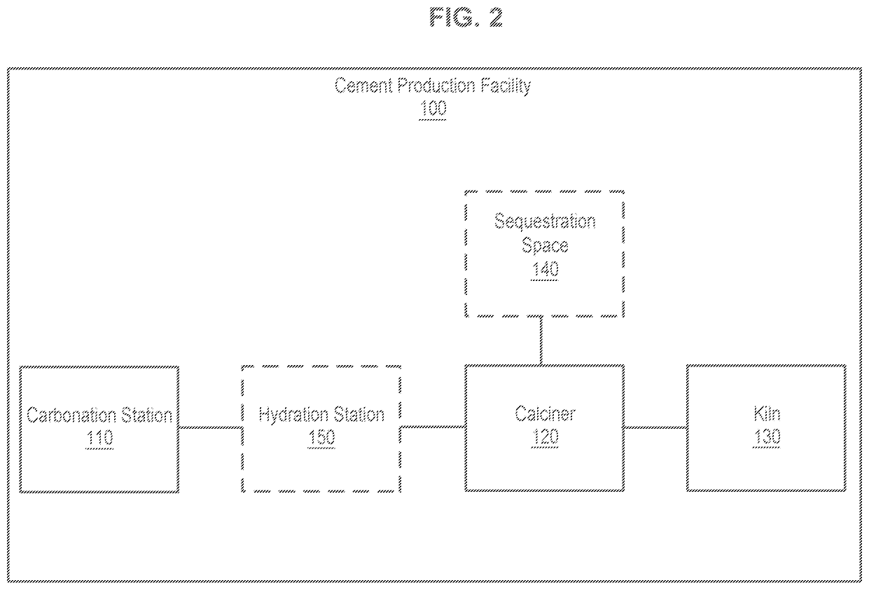

FIG. 2 shows a block diagram of a cement production facility 100, according to an embodiment. As shown, the cement production facility 100 includes a carbonation station 110, a calciner 120, a kiln 130, and optionally a sequestration space 140 and a hydration station 150. Lines interconnecting each of the process units represent flow of materials between each of the process units.

The carbonation station 110 receives CaO from the calciner 120 and contacts the CaO with ambient air to form CaCO₃. In some embodiments, the carbonation station 110 can include a plurality of carbonation plots positioned to expose the CaO to ambient conditions. In some embodiments, one or more of the carbonation plots can be placed in the vicinity of facilities with heavy CO₂ exhaust. In some embodiments, the carbonation plots can have any of the properties described in the '910 publication and/or the '572 application. In some embodiments, the carbonation plots can include sheets of CaO in powder form. In some embodiments, the carbonation plots can be arranged in stacked columns.

The calciner 120 receives CaCO₃ from both naturally occurring limestone and from the carbonation station 110. In some embodiments, the calciner 120 can include a total flow calciner, a fluidized bed calciner, a rotary kiln calciner, a riser reactor-calciner, a downer reactor-calciner, a separated tertiary air flow calciner, a hybrid calciner, or any other suitable calciner or combinations thereof. In some embodiments, the calciner 120 can be physically coupled to a power source. In some embodiments, the power source can include solar power, wind power, nuclear power, geothermal power, or any other renewable or low carbon power source or combinations thereof. In some embodiments, the calciner 120 can include a valve and gate system for controlling inputs and outputs. In some embodiments, the calciner 120 can be heated via electric resistance heating. In some embodiments, the calciner 120 can be heated via induction. In some embodiments, the calciner 120 can be heated via microwave heating. In some embodiments, the calciner 120 can have a calcination efficiency of at least about 85%, at least about 86%, at least about 87%, at least about 88%, at least about 89%, at least about 90%, at least about 91%, at least about 92%, at least about 93%, at least about 94%, at least about 95%, at least about 96%, at least about 97%, at least about 98%, or at least about 99%, inclusive of all values and ranges therebetween.

The kiln 130 receives CaO from the calciner 120. In some embodiments, the kiln 130 can include a rotary kiln. In some embodiments, the kiln 130 can rotate slowly about its longitudinal axis. In some embodiments, the kiln 130 can rotate at a rate of about 0.1 rpm, about 0.2 rpm, about 0.3 rpm, about 0.4 rpm, about 0.5 rpm, about 0.6 rpm, about 0.7 rpm, about 0.8 rpm, about 0.9 rpm, about 1 rpm, about 2 rpm, about 3 rpm, about 4 rpm, about 5 rpm, about 6 rpm, about 7 rpm, about 8 rpm, about 9 rpm, or about 10 rpm, inclusive of all values and ranges therebetween. In some embodiments, the kiln 130 can be at least partially powered by renewable energy (solar, wind, etc.).

In some embodiments, the sequestration space 140 can be fluidically coupled to the calciner 120 and receives CO₂ of high purity from the calciner 120. In some embodiments, post-processing equipment (not shown) can receive the CO₂ stream prior to the CO₂ stream reaching the sequestration space 140. In some embodiments, the post-processing equipment can include a condenser, a dehydrator, a compressor, or any combination thereof. In some embodiments, the sequestration space 140 can be co-located with the calciner 120. In some embodiments, the sequestration space 140 can be located underground. In some embodiments, the sequestration space 140 immediately underneath the calciner 120. In some embodiments, the sequestration space 140 can be located a sufficient distance away from the calciner 120, such that CO₂ is transported from the calciner 120 to the sequestration space (e.g., via fans and pipes). In some embodiments, the sequestration space 140 can include adsorbents to improve storage capacity. In some embodiments, the adsorbents can include activated carbon, graphene, silica, acrylonitrile, phosphorene, carbon nanotubes, biopolymers, or any other suitable adsorbent or combinations thereof. In some embodiments, the sequestration space 140 can be spatially separated from the calciner 120 and the CO₂ can be transported from the calciner 120 to the sequestration space 140. In some embodiments, the sequestration space 140 can be maintained at a pressure of about 1 bar (gauge), about 2 bar, about 3 bar, about 4 bar, about 5 bar, about 6 bar, about 7 bar, about 8 bar, about 9 bar, about 10 bar, about 15 bar, about 20 bar, about 25 bar, about 30 bar, about 35 bar, about 40 bar, about 45 bar, about 50 bar, about 55 bar, about 60 bar, about 65 bar, about 70 bar, about 75 bar, about 70 bar, about 75 bar, about 80 bar, about 85 bar, about 90 bar, about 95 bar, about 100 bar, about 150 bar, about 200 bar, about 250 bar, about 300 bar, about 350 bar, about 400 bar, about 450 bar, about 500 bar, about 550 bar, about 600 bar, about 650 bar, about 700 bar, about 750 bar, about 800 bar, about 850 bar, about 900 bar, about 950 bar, or about 1,000 bar, inclusive of all values and ranges therebetween.

The hydration station 150 is an optional intermediate station between the calciner 120 and the carbonation station 110. In some embodiments, CaO from the calciner can be hydrated at the hydration station to form Ca(OH)₂ as described above in step 16, with reference to FIG. 1. In some embodiments, the hydration station can include a water bath, one or more misting devices (e.g., water sprayers), a humid enclosure, or any combination thereof. In some embodiments, the hydration station 150 can include any of the hydration devices described in the '572 application.

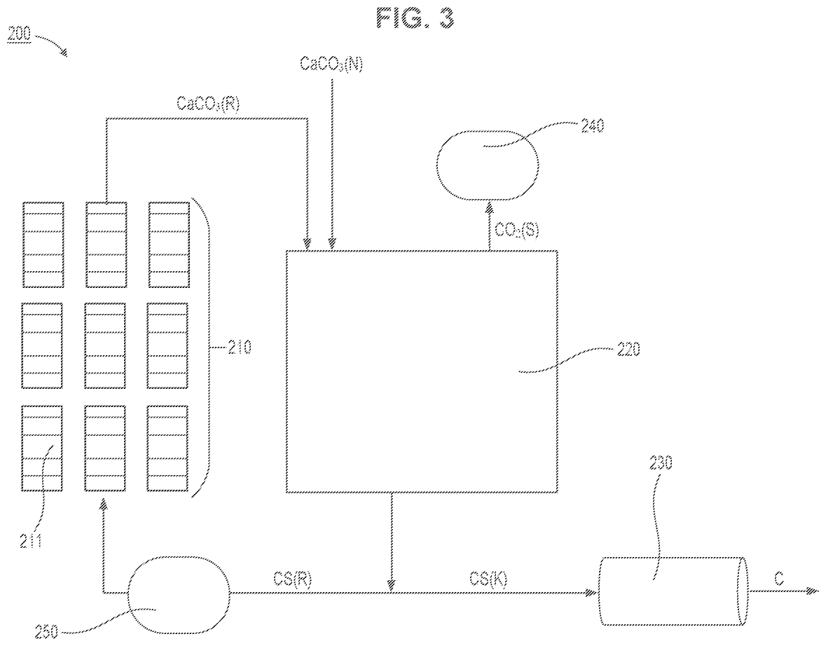

FIG. 3 is an illustration of a cement production facility 200, according to an embodiment. As shown, the cement production facility 200 includes a carbonation station 210 with carbonation contactors 211, a calciner 220, a kiln 230, a sequestration space 240, and a hydration station 250. In some embodiments, the carbonation station 210, the calciner 220, the kiln 230, the sequestration space 240, and the hydration station 250 can be the same or substantially similar to the carbonation station 110, the calciner 120, the kiln 130, the sequestration space 140, and the hydration station 150. Thus, certain aspects of the carbonation station 210, the calciner 220, the kiln 230, the sequestration space 240, and the hydration station 250 are not described in greater detail herein.

The carbonation station 210 includes the carbonation contactors 211. As shown, the carbonation station 210 includes nine carbonation plots 211. In some embodiments, the carbonation station 210 can include at least about 2, at least about 3, at least about 4, at least about 5, at least about 6, at least about 7, at least about 8, at least about 9, at least about 10, at least about 20, at least about 30, at least about 40, at least about 50, at least about 60, at least about 70, at least about 80, at least about 90, at least about 100, at least about 100, at least about 200, at least about 300, at least about 400, at least about 500, at least about 600, at least about 700, at least about 800, at least about 900, at least about 1,000, at least about 1,500, at least about 2,000, at least about 2,500, at least about 3,000, at least about 3,500, at least about 4,000, at least about 4,500, at least about 5,000, at least about 5,500, at least about 6,000, at least about 6,500, at least about 7,000, at least about 7,500, at least about 8,000, at least about 8,500, at least about 9,000, at least about 9,500, at least about 10,000, at least about 11,000, at least about 12,000, at least about 13,000, at least about 14,000, at least about 15,000, at least about 16,000, at least about 17,000, at least about 18,000, at least about 19,000, at least about 20,000, at least about 25,000, at least about 30,000, at least about 35,000, at least about 40,000, at least about 45,000, at least about 50,000, at least about 55,000, at least about 60,000, or at least about 65,000 carbonation plots 211. In some embodiments, the carbonation station 210 can include no more than about 70,000, no more than about 65,000, no more than about 60,000, no more than about 55,000, no more than about 50,000, no more than about 45,000, no more than about 40,000, no more than about 35,000, no more than about 30,000, no more than about 25,000, no more than about 20,000, no more than about 19,000, no more than about 18,000, no more than about 17,000, no more than about 16,000, no more than about 15,000, no more than about 14,000, no more than about 13,000, no more than about 12,000, no more than about 11,000, no more than about 10,000, no more than about 9,500, no more than about 9,000, no more than about 8,500, no more than about 8,000, no more than about 7,500, no more than about 7,000, no more than about 6,500, no more than about 6,000, no more than about 5,500, no more than about 5,000, no more than about 4,500, no more than about 4,000, no more than about 3,500, no more than about 3,000, no more than about 2,500, no more than about 2,000, no more than about 1,500, no more than about 1,000, no more than about 900, no more than about 800, no more than about 700, no more than about 600, no more than about 500, no more than about 400, no more than about 300, no more than about 200, no more than about 100, no more than about 90, no more than about 80, no more than about 70, no more than about 60, no more than about 50, no more than about 40, no more than about 30, no more than about 20, no more than about 10, no more than about 9, no more than about 8, no more than about 7, no more than about 6, no more than about 5, no more than about 4, or no more than about 3 carbonation plots 211.

Combinations of the above-referenced numbers of carbonation plots in the carbonation station 210 are also possible (e.g., at least about 2 and no more than about 70,000 or at least about 500 and no more than about 5,000, inclusive of all values and ranges therebetween. In some embodiments, the carbonation station 210 can include about 2, about 3, about 4, about 5, about 6, about 7, about 8, about 9, about 10, about 20, about 30, about 40, about 50, about 60, about 70, about 80, about 90, about 100, about 100, about 200, about 300, about 400, about 500, about 600, about 700, about 800, about 900, about 1,000, about 1,500, about 2,000, about 2,500, about 3,000, about 3,500, about 4,000, about 4,500, about 5,000, about 5,500, about 6,000, about 6,500, about 7,000, about 7,500, about 8,000, about 8,500, about 9,000, about 9,500, about 10,000, about 11,000, about 12,000, about 13,000, about 14,000, about 15,000, about 16,000, about 17,000, about 18,000, about 19,000, about 20,000. about 25,000, about 30,000. about 35,000, about 40,000. about 45,000, about 50,000. about 55,000, about 60,000. about 65,000, or about 70,000 carbonation plots 211.

In some embodiments, the carbonation plots 211 can include sheets of CaO. In some embodiments, the carbonation plots 211 can have length and/or width dimensions of at least about 10 cm, at least about 20 cm, at least about 30 cm, at least about 40 cm, at least about 50 cm, at least about 60 cm, at least about 70 cm, at least about 80 cm, at least about 90 cm, at least about 1 m, at least about 1.1 m, at least about 1.2 m, at least about 1.3 m, at least about 1.3 m, at least about 1.4 m, at least about 1.5 m, at least about 2 m, at least about 2.5 m, at least about 3 m, at least about 3.5 m, at least about 4 m, at least about 4.5 m, at least about 5 m, at least about 5.5 m, at least about 6 m, at least about 6.5 m, at least about 7 m, at least about 7.5 m, at least about 8 m, at least about 8.5 m, at least about 9 m, or at least about 9.5 m. In some embodiments, the carbonation plots 211 can have length and/or width dimensions of no more than about 10 m, no more than about 9.5 m, no more than about 9 m, no more than about 8.5 m, no more than about 8 m, no more than about 7.5 m, no more than about 7 m, no more than about 6.5 m, no more than about 6 m, no more than about 5.5 m, no more than about 5 m, no more than about 4.5 m, no more than about 4 m, no more than about 3.5 m, no more than about 3 m, no more than about 2.5 m, no more than about 2 m, no more than about 1.9 m, no more than about 1.8 m, no more than about 1.7 m, no more than about 1.6 m, no more than about 1.5 m, no more than about 1.4 m, no more than about 1.3 m, no more than about 1.2 m, no more than about 1.1 m, no more than about 1 m, no more than about 90 cm, no more than about 80 cm, no more than about 70 cm, no more than about 60 cm, no more than about 50 cm, no more than about 40 cm, no more than about 30 cm, or no more than about 20 cm. Combinations of the above-referenced length and width dimensions of the carbonation plots 211 are also possible (e.g., at least about 10 cm and no more than about 10 m or at least about 50 cm and no more than about 5 m), inclusive of all values and ranges therebetween. In some embodiments, the carbonation plots 211 can have length and/or width dimensions of about 10 cm, about 20 cm, about 30 cm, about 40 cm, about 50 cm, about 60 cm, about 70 cm, about 80 cm, about 90 cm, about 1 m, about 1.1 m, about 1.2 m, about 1.3 m, about 1.4 m, about 1.5 m, about 1.6 m, about 1.7 m, about 1.8 m, about 1.9 m, about 2 m, about 2.5 m, about 3 m, about 3.5 m, about 4 m, about 4.5 m, about 5 m, about 5.5 m, about 6 m, about 6.5 m, about 7 m, about 7.5 m, about 8 m, about 8.5 m, about 9 m, about 9.5 m, or about 10 m.

In some embodiments, the carbonation plots 211 can include thin sheets of calcium-containing powder. In some embodiments, the carbonation plots 211 can include sheets with thicknesses of at least about 1 mm, at least about 2 mm, at least about 3 mm, at least about 4 mm, at least about 5 mm, at least about 6 mm, at least about 7 mm, at least about 8 mm, at least about 9 mm, at least about 1 cm, at least about 2 cm, at least about 3 cm, at least about 4 cm, at least about 5 cm, at least about 6 cm, at least about 7 cm, at least about 8 cm, or at least about 9 cm. In some embodiments, the carbonation plots 211 can include sheets with thicknesses of no more than about 10 cm, no more than about 9 cm, no more than about 8 cm, no more than about 7 cm, no more than about 6 cm, no more than about 5 cm, no more than about 4 cm, no more than about 3 cm, no more than about 2 cm, no more than about 1 cm, no more than about 9 mm, no more than about 8 mm, no more than about 7 mm, no more than about 6 mm, no more than about 5 mm, no more than about 4 mm, no more than about 3 mm, or no more than about 2 mm. Combinations of the above-referenced sheet thicknesses are also possible (e.g., at least about 1 mm and no more than about 10 cm or at least about 5 mm and no more than about 1 cm), inclusive of all values and ranges therebetween. In some embodiments, the carbonation plots 211 can include sheets with thicknesses of about 1 mm, about 2 mm, about 3 mm, about 4 mm, about 5 mm, about 6 mm, about 7 mm, about 8 mm, about 9 mm, about 1 cm, about 2 cm, about 3 cm, about 4 cm, about 5 cm, about 6 cm, about 7 cm, about 8 cm, about 9 cm, or about 10 cm.

In some embodiments, the thin sheets of calcium-containing powder of the carbonation plots 211 can be arranged in trays. In some embodiments, the trays can be stacked vertically. In some embodiments, each the carbonation plots 211 can include at least about 1, at least about 2, at least about 3, at least about 4, at least about 5, at least about 6, at least about 7, at least about 8, at least about 9, at least about 10, at least about 20, at least about 30, at least about 40, at least about 50, at least about 60, at least about 70, at least about 80, at least about 90, at least about 100, at least about 200, at least about 300, at least about 400, at least about 500, at least about 600, at least about 700, at least about 800, at least about 900, at least about 1,000, at least about 1,500, at least about 2,000, at least about 2,500, at least about 3,000, at least about 3,500, at least about 4,000, or at least about 4,500 trays. In some embodiments, each of the carbonation plots 211 can include no more than about 5,000, no more than about 4,500, no more than about 4,000, no more than about 3,500, no more than about 3,000, no more than about 2,500, no more than about 2,000, no more than about 1,500, no more than about 1,000, no more than about 900, no more than about 800, no more than about 700, no more than about 600, no more than about 500, no more than about 400, no more than about 300, no more than about 200, no more than about 100, no more than about 90, no more than about 80, no more than about 70, no more than about 60, no more than about 50, no more than about 40, no more than about 30, no more than about 20, no more than about 10, no more than about 9, no more than about 8, no more than about 7, no more than about 6, no more than about 5, no more than about 4, no more than about 3, or no more than about 2 trays. Combinations of the above-referenced numbers of trays in each of the carbonation plots 211 are also possible (e.g., at least about 1 and no more than about 5,000 or at least about 50 and no more than about 500), inclusive of all values and ranges therebetween. In some embodiments, the trays can be stacked vertically. In some embodiments, each the carbonation plots 211 can include about 1, about 2, about 3, about 4, about 5, about 6, about 7, about 8, about 9, about 10, about 20, about 30, about 40, about 50, about 60, about 70, about 80, about 90, about 100, about 200, about 300, about 400, about 500, about 600, about 700, about 800, about 900, about 1,000, about 1,500, about 2,000, about 2,500, about 3,000, about 3,500, about 4,000, about 4,500, or about 5,000 trays.

In some embodiments, the carbonation plots 211 can include CaO powder. In some embodiments, the CaO powder can have an average particle size of at least about 5 μm, at least about 10 μm, at least about 15 μm, at least about 20 μm, at least about 25 μm, at least about 30 μm, at least about 35 μm, at least about 40 μm, at least about 45 μm, at least about 50 μm, at least about 100 μm, at least about 150 μm, at least about 200 μm, at least about 250 μm, at least about 300 μm, at least about 350 μm, at least about 400 μm, at least about 450 μm, at least about 500 μm, at least about 550 μm, at least about 600 μm, at least about 650 μm, at least about 700 μm, at least about 750 μm, at least about 800 μm, at least about 850 μm, at least about 900 μm, or at least about 950 μm. In some embodiments, the CaO powder can have an average particle size of no more than about 1 mm, no more than about 950 μm, no more than about 900 μm, no more than about 850 μm, no more than about 800 μm, no more than about 750 μm, no more than about 700 μm, no more than about 650 μm, no more than about 600 μm, no more than about 550 μm, no more than about 500 μm, no more than about 450 μm, no more than about 400 μm, no more than about 350 μm, no more than about 300 μm, no more than about 250 μm, no more than about 200 μm, no more than about 150 μm, no more than about 100 μm, no more than about 50 μm, no more than about 45 μm, no more than about 40 μm, no more than about 35 μm, no more than about 30 μm, no more than about 25 μm, no more than about 20 μm, no more than about 15 μm, or no more than about 10 μm. Combinations of the above-referenced particle sizes of the CaO powder are also possible (e.g., at least about 5 μm and no more than about 1 mm or at least about 20 μm and no more than about 600 μm, inclusive of all values and ranges therebetween. In some embodiments, the CaO powder can have an average particle size of about 5 μm, about 10 μm, about 15 μm, about 20 μm, about 25 μm, about 30 μm, about 35 μm, about 40 μm, about 45 μm, about 50 μm, about 100 μm, about 150 μm, about 200 μm, about 250 μm, about 300 μm, about 350 μm, about 400 μm, about 450 μm, about 500 μm, about 550 μm, about 600 μm, about 650 μm, about 700 μm, about 750 μm, about 800 μm, about 850 μm, about 900 μm, about 950 μm, or about 1 mm.

In some embodiments, the carbonation plots 211 can include CaCO₃ powder. In some embodiments, the CaCO₃ powder can have an average particle size of at least about 5 μm, at least about 10 μm, at least about 15 μm, at least about 20 μm, at least about 25 μm, at least about 30 μm, at least about 35 μm, at least about 40 μm, at least about 45 μm, at least about 50 μm, at least about 100 μm, at least about 150 μm, at least about 200 μm, at least about 250 μm, at least about 300 μm, at least about 350 μm, at least about 400 μm, at least about 450 μm, at least about 500 μm, at least about 550 μm, at least about 600 μm, at least about 650 μm, at least about 700 μm, at least about 750 μm, at least about 800 μm, at least about 850 μm, at least about 900 μm, or at least about 950 μm. In some embodiments, the CaCO₃ powder can have an average particle size of no more than about 1 mm, no more than about 950 μm, no more than about 900 μm, no more than about 850 μm, no more than about 800 μm, no more than about 750 μm, no more than about 700 μm, no more than about 650 μm, no more than about 600 μm, no more than about 550 μm, no more than about 500 μm, no more than about 450 μm, no more than about 400 μm, no more than about 350 μm, no more than about 300 μm, no more than about 250 μm, no more than about 200 μm, no more than about 150 μm, no more than about 100 μm, no more than about 50 μm, no more than about 45 μm, no more than about 40 μm, no more than about 35 μm, no more than about 30 μm, no more than about 25 μm, no more than about 20 μm, no more than about 15 μm, or no more than about 10 μm. Combinations of the above-referenced particle sizes of the CaCO₃ powder are also possible (e.g., at least about 50 μm and no more than about 1 mm or at least about 200 μm and no more than about 600 μm, inclusive of all values and ranges therebetween. In some embodiments, the CaCO₃ powder can have an average particle size of about 5 μm, about 10 μm, about 15 μm, about 20 μm, about 25 μm, about 30 μm, about 35 μm, about 40 μm, about 45 μm, about 50 μm, about 100 μm, about 150 μm, about 200 μm, about 250 μm, about 300 μm, about 350 μm, about 400 μm, about 450 μm, about 500 μm, about 550 μm, about 600 μm, about 650 μm, about 700 μm, about 750 μm, about 800 μm, about 850 μm, about 900 μm, about 950 μm, or about 1 mm.

In some embodiments, the carbonation plots 211 can include Ca(OH)₂ powder. In some embodiments, the Ca(OH)₂ powder can have an average particle size of at least about 5 μm, at least about 10 μm, at least about 15 μm, at least about 20 μm, at least about 25 μm, at least about 30 μm, at least about 35 μm, at least about 40 μm, at least about 45 μm, at least about 50 μm, at least about 100 μm, at least about 150 μm, at least about 200 μm, at least about 250 μm, at least about 300 μm, at least about 350 μm, at least about 400 μm, at least about 450 μm, at least about 500 μm, at least about 550 μm, at least about 600 μm, at least about 650 μm, at least about 700 μm, at least about 750 μm, at least about 800 μm, at least about 850 μm, at least about 900 μm, or at least about 950 μm. In some embodiments, the Ca(OH)₂ powder can have an average particle size of no more than about 1 mm, no more than about 950 μm, no more than about 900 μm, no more than about 850 μm, no more than about 800 μm, no more than about 750 μm, no more than about 700 μm, no more than about 650 μm, no more than about 600 μm, no more than about 550 μm, no more than about 500 μm, no more than about 450 μm, no more than about 400 μm, no more than about 350 μm, no more than about 300 μm, no more than about 250 μm, no more than about 200 μm, no more than about 150 μm, no more than about 100 μm, no more than about 50 μm, no more than about 45 μm, no more than about 40 μm, no more than about 35 μm, no more than about 30 μm, no more than about 25 μm, no more than about 20 μm, no more than about 15 μm, or no more than about 10 μm. Combinations of the above-referenced particle sizes of the Ca(OH)₂ powder are also possible (e.g., at least about 50 μm and no more than about 1 mm or at least about 200 μm and no more than about 600 μm, inclusive of all values and ranges therebetween. In some embodiments, the Ca(OH)₂ powder can have an average particle size of about 5 μm, about 10 μm, about 15 μm, about 20 μm, about 25 μm, about 30 μm, about 35 μm, about 40 μm, about 45 μm, about 50 μm, about 100 μm, about 150 μm, about 200 μm, about 250 μm, about 300 μm, about 350 μm, about 400 μm, about 450 μm, about 500 μm, about 550 μm, about 600 μm, about 650 μm, about 700 μm, about 750 μm, about 800 μm, about 850 μm, about 900 μm, about 950 μm, or about 1 mm.

The calciner 220 receives a naturally occurring CaCO₃ stream (CaCO₃(N)) and a recycled CaCO₃ stream (CaCO₃(R)). As shown, the naturally occurring stream CaCO₃(N) and the recycled stream CaCO₃(R) are fed through a single gate. In some embodiments, the naturally occurring CaCO₃(N) can be fed through a first gate and the recycled CaCO₃(R) can be fed through a second gate. In some embodiments, an inlet into the calciner 220 can include a hopper for mass storage and discharge. In some embodiments, the hopper can include a divider, such that the naturally occurring stream CaCO₃(N) and the recycled stream CaCO₃(R) can be remain separated from each other prior to entering the calciner 220.

In the calciner 220, both the naturally occurring CaCO₃(N) and the recycled CaCO₃(R) are chemically converted to a product stream that includes CaO and CO₂ with potentially some Ca(OH)₂ and potentially some residual CaCO₃. The CO₂ is fed to the sequestration space 240 in a sequestered carbon dioxide (CO₂(S)) stream. The solid products from the calciner 220, including the CaO, the Ca(OH)₂, and the residual CaCO₃ are divided into a recycled calcination stream (CS(R)) and a kiln calcination stream (CS(K)). The recycled calcination stream CS(R) is fed back to the carbonation station 210, while the kiln calcination stream CS(K) is fed to the kiln 230. In some embodiments, the recycled calcination stream CS(R) and the kiln calcination stream CS(K) can be separated prior to exiting the calciner 220. In some embodiments, the recycled calcination stream CS(R) and the kiln calcination stream CS(K) can be separated after exiting the calciner 220. Upon entering the kiln 230, the kiln calcination stream CS(K) reacts with clay and iron ore to produce a clinker C, which is then further processed and grinded with slag and gypsum to produce cement.

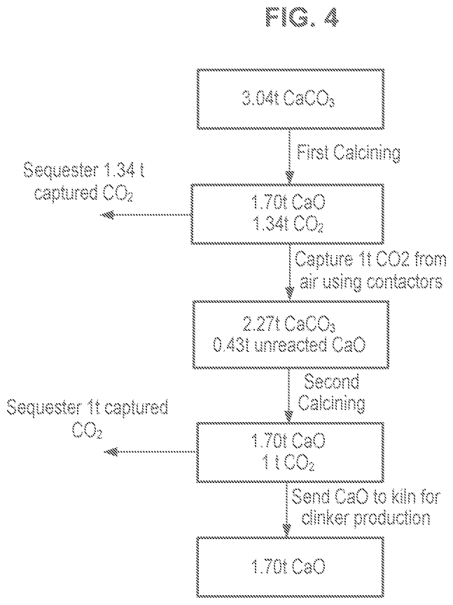

FIG. 4 shows a material balance of a quantity of calcium atoms passing through a calciner twice, according to various embodiments. FIG. 4 demonstrates the ability of processes and facilities described herein to sequester additional carbon dioxide. This process is scaled for one extra ton of CO₂ to be extracted from the air, as compared to a process with a single calciner pass. The process begins with 3.04 tons of naturally occurring CaCO₃ passing through a calciner a first time to produce 1.70 tons of CaO and 1.34 tons of CO₂. The 1.34 tons of CO₂ are sequestered. The 1.70 tons of CaO are then fed to a carbonation station, where approximately 1.27 tons of CaO react with 1 ton of CO₂ (per the stoichiometry of the reaction) to form 2.27 tons of CaCO₃ with 0.43 tons of unreacted CaO left over. The mixture of CaCO₃ and CaO is fed back to the calciner a second time, where the CaCO₃ is calcined to form 1.27 tons of CaO and 1 ton of CO₂. Adding the unreacted CaO from the previous carbonation, the mixture includes 1.70 tons of CaO and 1 ton of CO₂. The 1.70 tons of CaO are then fed to a kiln for clinker production. In addition to the 1 extra ton of CO₂ removed from the air, an additional 0.35 tons of CO₂ can be saved from the cement production process if renewable fuels are used to power the calciner, as opposed to natural gas.

### Example 1—Carbon Negative Cement Production

Embodiments described herein can give way to a cement production process that removes more CO₂ from the atmosphere than it produces (i.e., a carbon-negative cement production process). An example of a scenario, in which a process is carbon negative can begin with the addition of 2 tons of CaCO₃ to a calciner for a first pass. The first calcination of the CaCO₃ yields 1.12 tons of CaO and 0.86 tons of CO₂. The CO₂ is captured and sequestered. The energy for the calcination is provided by renewable electricity, which results in no CO₂ direct emissions. The CaO is then carbonated at a carbonation station, where 0.84 tons of the CaO capture 0.66 tons of CO₂ from the air, yielding 1.5 tons of CaCO₃, with 0.28 tons of CaO remaining unreacted. The stream that includes 1.5 tons of CaCO₃ and 0.28 tons of CaO is sent back to the calciner, where the calciner produces a stream with approximately 1.1 tons of CO₂. With a calcination efficiency of 98%, the second calcination step captures and sequesters 0.65 tons of CO₂, which were previously captured from the air. This calcination once again produces no direct CO₂ emissions when energy for calcination is provided by renewable electricity.

The CaO from the second calcination can make up about 65 wt % of the clinker content in the cement-making process. Therefore, the 1.1 tons of CaO will produce a clinker with a weight of about 1.7 tons. In this process, 0.86 tons of CO₂ emissions are avoided by capturing the CO₂ from the initial decarbonation process. If 3.6 GJ of energy is required to produce one metric ton of CaO and the emissions associated with this energy production via natural gas is 0.06 kg of CO₂ per GJ, then replacing the calcination energy resource further reduces the CO₂ emissions by 0.23 tons of CO₂. The ambient recarbonation of the material directly captures 0.65 tons of CO₂ from air during each cycle. These are shown in Table 1.

TABLE 1
CO₂ reduction from use of carbonation

| | | |
|---|---|---|
| Step | tCO₂ | tCO₂/tClinker |

CO₂ Reduction from Cement-Making Process = 0.64 tCO₂/tClinker

| | | |
|---|---|---|
| Decarbonating initial limestone | 0.86 | 0.51 |
| Renewable electricity for calcination | 0.23 | 0.13 |

CO₂ Removals from Ambient Recarbonation = 0.38 tCO₂/tClinker

| | | |
|---|---|---|
| Captured from air (each cycle) | 0.65 | 0.38 |

In typical cement-making operations, total emissions are about 0.825-0.89 tons of CO₂ per ton of clinker. After one ambient look, the total emissions reduction would total about 0.64 tons of CO₂ per ton of clinker. Reducing the residual emissions from the remainder of the process to approximately 0.185-0.25 tons of CO₂ per ton of clinker. After an additional ambient look, a cement production system with a carbonation station removes an additional 0.38 tons of CO₂ from, the air, which results in net emissions of −0.13 to −0.195 tons of CO₂ per ton of clinker. In other words, 0.13-0.195 tons of CO₂ are removed from the atmosphere. Additional cycles of the material (i.e., the calcium-containing material) would result in increased CO₂ removal from the atmosphere, and therefore, increasingly carbon negative cement production. This is true in the case where all of the CO₂ reductions and CO₂ removals are allocated to cement production.

Various concepts may be embodied as one or more methods, of which at least one example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments. Put differently, it is to be understood that such features may not necessarily be limited to a particular order of execution, but rather, any number of threads, processes, services, servers, and/or the like that may execute serially, asynchronously, concurrently, in parallel, simultaneously, synchronously, and/or the like in a manner consistent with the disclosure. As such, some of these features may be mutually contradictory, in that they cannot be simultaneously present in a single embodiment. Similarly, some features are applicable to one aspect of the innovations, and inapplicable to others.

In addition, the disclosure may include other innovations not presently described. Applicant reserves all rights in such innovations, including the right to embodiment such innovations, file additional applications, continuations, continuations-in-part, divisional s, and/or the like thereof. As such, it should be understood that advantages, embodiments, examples, functional, features, logical, operational, organizational, structural, topological, and/or other aspects of the disclosure are not to be considered limitations on the disclosure as defined by the embodiments or limitations on equivalents to the embodiments. Depending on the particular desires and/or characteristics of an individual and/or enterprise user, database configuration and/or relational model, data type, data transmission and/or network framework, syntax structure, and/or the like, various embodiments of the technology disclosed herein may be implemented in a manner that enables a great deal of flexibility and customization as described herein.

All definitions, as defined and used herein, should be understood to control over dictionary definitions, definitions in documents incorporated by reference, and/or ordinary meanings of the defined terms.

As used herein, in particular embodiments, the terms “about” or “approximately” when preceding a numerical value indicates the value plus or minus a range of 10%. Where a range of values is provided, it is understood that each intervening value, to the tenth of the unit of the lower limit unless the context clearly dictates otherwise, between the upper and lower limit of that range and any other stated or intervening value in that stated range is encompassed within the disclosure. That the upper and lower limits of these smaller ranges can independently be included in the smaller ranges is also encompassed within the disclosure, subject to any specifically excluded limit in the stated range. Where the stated range includes one or both of the limits, ranges excluding either or both of those included limits are also included in the disclosure.

The phrase “and/or,” as used herein in the specification and in the embodiments, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the embodiments, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the embodiments, “consisting of,” will refer to the inclusion of exactly one element of a number or list of elements. In general, the term “or” as used herein shall only be interpreted as indicating exclusive alternatives (i.e., “one or the other but not both”) when preceded by terms of exclusivity, such as “either,” “one of,” “only one of,” or “exactly one of.” “Consisting essentially of,” when used in the embodiments, shall have its ordinary meaning as used in the field of patent law.

As used herein in the specification and in the embodiments, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

In the embodiments, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

While specific embodiments of the present disclosure have been outlined above, many alternatives, modifications, and variations will be apparent to those skilled in the art. Accordingly, the embodiments set forth herein are intended to be illustrative, not limiting. Various changes may be made without departing from the spirit and scope of the disclosure. Where methods and steps described above indicate certain events occurring in a certain order, those of ordinary skill in the art having the benefit of this disclosure would recognize that the ordering of certain steps may be modified and such modification are in accordance with the variations of the invention. Additionally, certain of the steps may be performed concurrently in a parallel process when possible, as well as performed sequentially as described above. The embodiments have been particularly shown and described, but it will be understood that various changes in form and details may be made.

1. A method, comprising:
transferring a calciner input stream to a calciner, the calciner input stream including calcium carbonate;
applying heat to the calciner to decompose the calciner input stream into a calciner product stream and a CO₂ stream, the calciner product stream including calcium oxide;
sequestering the CO₂ stream;
dividing the calciner product stream into a first calciner product stream and a second calciner product stream;
transferring the first calciner product stream to a carbonation station;
contacting the calcium oxide in the first calciner product stream with ambient air in the carbonation station to form the calciner input stream; and
transferring the second calciner product stream to a kiln to produce a clinker.

2. The method of claim 1, wherein the calciner input stream is a recycled stream transferred from the carbonation station, the method further comprising:
transferring a makeup stream to the calciner, the makeup stream including calcium carbonate.

3. The method of claim 2, further comprising:
transferring the calciner input stream through a first gate coupled to the calciner; and
transferring the makeup stream through a second gate coupled to the calciner.

4. The method of claim 2, wherein the makeup stream includes naturally occurring limestone.

5. The method of claim 1, further comprising:
hydrating at least a portion the first calciner product stream to produce calcium hydroxide; and
contacting the calcium hydroxide with ambient air at the carbonation station to form water and a quantity of calcium carbonate, the quantity of calcium carbonate included in the calciner input stream.

6. The method of claim 1, further comprising:
adding at least one of clay or iron ore to the second calciner product stream prior to transferring the second calciner product stream to the kiln.

7. The method of claim 1, wherein the carbonation station includes an array of carbonation plots configured to expose the calcium oxide in the first calciner product stream to ambient air.

8. The method of claim 7, wherein the calcium oxide is a powder and has an average particle size of no more than about 500 μm.

9. The method of claim 1, wherein heat applied to the calciner is from a renewable energy source.

10. The method of claim 1, wherein the heat applied to the calciner is via electric resistance heating, and the electricity for the electric resistance heating is provided from a renewable energy source.

11. The method of claim 1, wherein the heat is applied to the calciner via at least one of induction or microwave heating.

12. The method of claim 1, wherein the sequestered CO₂ stream includes at least about 80 vol % CO₂.

13. The method of claim 1, wherein the second calciner product stream has a mass flow rate of less than about 2.0 times a mass flow rate of the first calciner product stream.

14. The method of claim 1, wherein the first calciner product stream has a mass flow rate of less than about 1.5 times as much as a mass flow rate of the second calciner product stream.

15. A method, comprising:
transferring a first calciner input stream to a calciner, the first calciner input stream including a recycled carbon-containing material;
transferring a second calciner input stream to the calciner, the second calciner input stream including a fresh carbon-containing material;
applying heat to the calciner to decompose the first calciner input stream and the second calciner input stream into a calciner product stream and a CO₂ stream, the calciner product stream including a carbonation medium;
sequestering the CO₂ stream;
dividing the calciner product stream into a first calciner product stream and a second calciner product stream;
transferring the first calciner product stream to a carbonation station;
contacting the carbonation medium in the first calciner product stream with ambient air in the carbonation station to form the first calciner input stream; and
transferring the second calciner product stream to a kiln to produce a clinker.

16. The method of claim 15, wherein the recycled carbon-containing material and the fresh carbon-containing material each include calcium carbonate.

17. The method of claim 15, wherein the fresh carbon-containing material includes limestone.

18. The method of claim 15, further comprising:
hydrating at least a portion the first calciner product stream to produce a hydroxylated product; and
contacting the hydroxylated product with ambient air in the carbonation station to form water and a quantity of carbon-containing material, the quantity of carbon-containing material included in the first calciner input stream.

19. The method of claim 15, further comprising:
adding at least one of clay or iron ore to the second calciner product stream prior to transferring the second calciner product stream to the kiln.

20. A cement production facility, comprising:
a carbonation station including a carbonation medium configured to adsorb CO₂ from ambient air to form a first stream of calcium carbonate;
a calciner configured to receive the first stream of calcium carbonate from the carbonation station and a second stream of naturally occurring calcium carbonate, the calciner configured to heat the first stream of calcium carbonate and the second stream of calcium carbonate to form a product stream and a CO₂ stream; and
a kiln configured to receive at least a portion of the product stream to produce a clinker.

21. The cement production facility of claim 20, further comprising:
a sequestration space fluidically coupled to the calciner and configured to receive the CO₂ stream.

22. The cement production facility of claim 20, further comprising:
a hydration station configured to hydrate at least a portion of the product stream to improve CO₂ adsorption capacity of the at least a portion of the product stream.

23. The cement production facility of claim 20, wherein the kiln is configured to receive a first portion of the product stream and the carbonation station is configured to receive a second portion of the product stream.

24. The cement production facility of claim 20, wherein the carbonation station includes a plurality of carbonation plots, the plurality of carbonation plots including sheets of calcium oxide.

25. The cement production facility of claim 20, further comprising:
a power source configured to power the calciner, the power source including at least one of a solar power source, a wind power source, a geothermal source, or a nuclear source.
